(19) United States
(12) Patent Application Publication
(10) Pub. No.: US 2003/0231274 A1
(43) Pub. Date: Dec. 18, 2003

(54) MVA pixel for liquid crystal display

(75) Inventor: Yang-En Wu, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: AU Optronics Corp.

(21) Appl. No.: 10/461,670

(22) Filed: Jun. 13, 2003

(30) Foreign Application Priority Data
Jun. 18, 2002 (TW) 91113273

(51) Int. Cl. G02F 1/1343

(52) U.S. Cl. 349/143

(57) ABSTRACT

A MVA pixel for a liquid crystal display. The MVA pixel comprises a protrusion element formed on an inner surface of a first panel and a conducting layer with a first slit and a second slit formed on an inner surface of a second panel, wherein the protrusion element faces the first slit. A liquid crystal layer is disposed between the first panel and the second panel.

### BACKGROUND OF THE INVENTION

1. Field of the Invention

The present invention relates in general to a multi-domain vertical alignment (MVA) pixel for liquid crystal display (LCD). In particular, the present invention relates to pixels for a high resolution, multi-domain vertical alignment (MVA), liquid crystal display.

2. Description of the Related Art

Liquid Crystal Displays (LCDs) are widely utilized in the personal computers, digital camera and projectors because of its low power consumption, thin profile, light weight, and low driving voltage.

However, LCDs present several disadvantages and limitations, among narrow view angle. At present, a number of propositions for manufacturing wide view angle LCD are in the developing stage. The most widely adopted technique is the so-called multi-domain vertical alignment (MVA) technology. The alternately positioned slit-spacing-protrusion structure in each pixel is used and a single pixel is divided into several domains so that liquid crystal molecules in different domains have different tilt directions. Hence, view angle of the LCD is increased.

FIG. 1 shows a top view of the traditional MVA pixel. In the figure, reference numeral 10 indicates a storage capacitor, reference numeral 20 indicates bumps, and reference numeral 30 indicates slits. FIG. 2 is a cross-section taken along A-A′ cut line of FIG. 1. In the figure, reference numeral 40 indicates transparent electrodes formed of, for example, ITO or SnO, reference numeral 50 indicates an upper panel, reference numeral 60 indicates a lower panel, and reference numeral 80 indicates liquid crystal molecules. Because the slits 30 and the bumps 20 are alternately arranged and inclined in each MVA pixel, electric field directions are different in some regions when a voltage is applied across the pixel area. In other words, the regions I totally controlled by the tilted slits 30 and tilted bumps 20 have better light transmittance, as shown in FIG. 1, which are called bright regions. The peripheral regions II of the pixel are dull regions, because the electric field is different from the desired electric field. The brightness of the dull regions II is about 65% of the bright regions I.

As can be seen in FIG. 1, the total transmittance of the traditional MVA pixel is not high enough, and its effective aperture ratio is only about 30% in 200 dpi. It is known that if MVA technology is adapted to high resolution LCDs (150 dpi-200 dpi over), the bright regions I may shrink with improvement of resolution, and the LCDs cannot be used due to its bad transmittance efficiency. Therefore, increasing the area of the bright regions and reducing the area of the dull regions in each MVA pixel is important for high resolution LCDs.

### SUMMARY OF THE INVENTION

An object of the present invention is thus to provide a MVA pixel for a liquid crystal display comprising a liquid crystal layer between a first glass panel and a second glass panel. The MVA pixel comprises a protrusion element formed on an inner surface of the first glass panel and a conducting layer with a first slit and a second slit formed on an inner surface of the second glass panel, wherein the protrusion element is disposed facing the first slit.

### BRIEF DESCRIPTION OF THE DRAWINGS

The present invention will become more fully understood from the detailed description given herein and the accompanying drawings, given by way of illustration only and thus not intended to be limitative of the present invention.

FIG. 1 shows a top view of a traditional MVA pixel.

FIG. 2 shows a cross-section taken along A-A′ cut line of FIG. 1.

FIG. 3 shows a top view of a MVA pixel according to an embodiment of the present invention.

FIG. 4 shows a cross-section taken along B-B′ cut line of FIG. 3.

FIG. 5 shows a top view of arranged MVA pixels according to an embodiment of the present invention.

### DETAILED DESCRIPTION OF THE INVENTION

FIG. 3 shows a top view of a MVA pixel according to the embodctive view of still another embodiment of a flow controller according to the present invention, included in a different exemplary valve assembly.

### DESCRIPTION OF THE PREFERRED EMBODIMENT

First Embodiment of Flow Controller

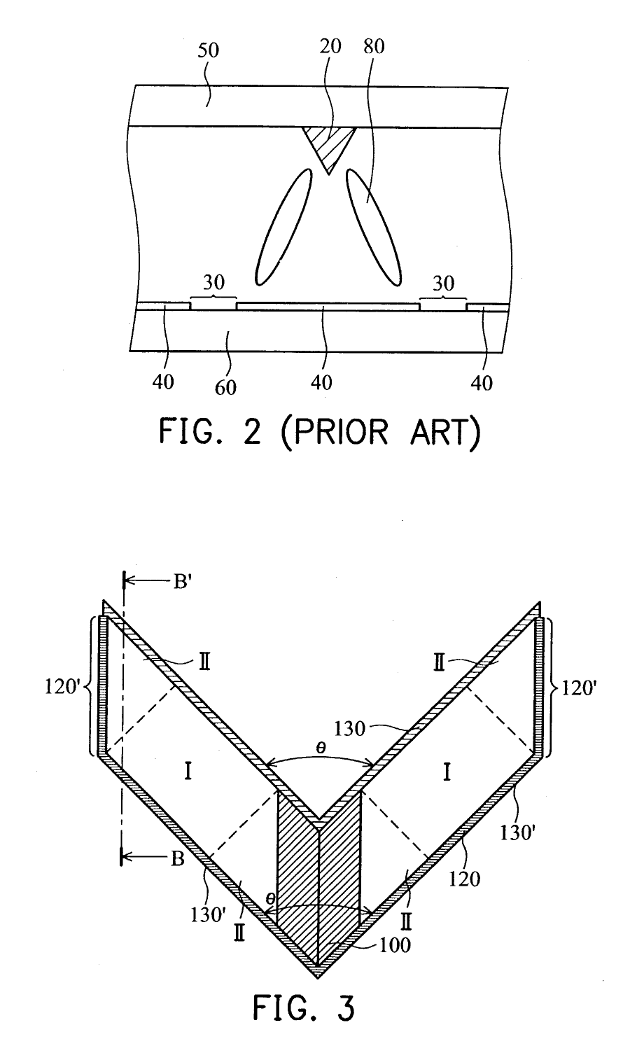

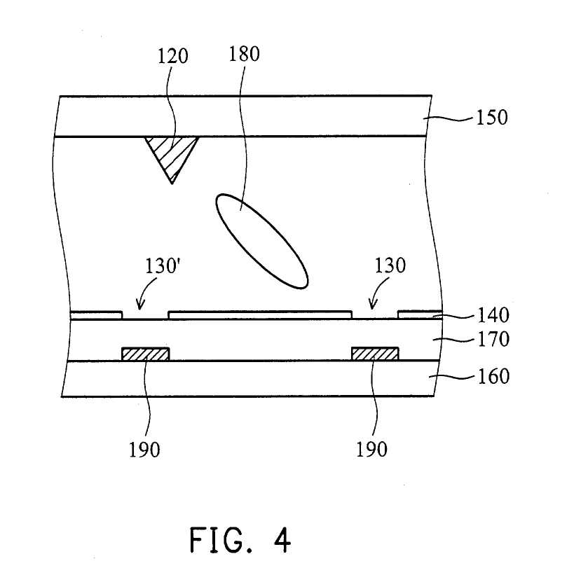

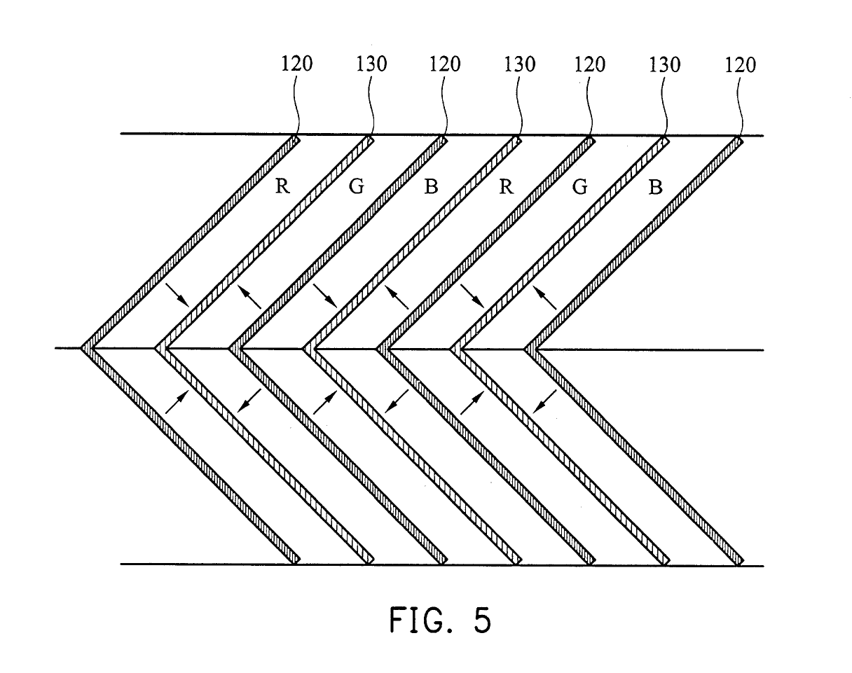

FIGS. 2-5 illustrate a first embodiment of a flow controller 20 that adjusts the flow of compressed gas through a recock gas passageway 22, in accord with the present invention. As shown therein, the flow controller and recock gas passageway are disposed within a valve assembly 24 that is included in an exemplary pneumatic gun 28. Valve assembly 24 is normally closed and opens as a result of an impact by a spring driven component when the gun is fired. Pneumatic gun 28 is configured for propelling paintballs, but can readily be alternatively configured for propelling other types of projectiles, such as BBs or pellets.

As shown in FIG. 2, pneumatic gun 28 includes a frame 32 with a forward end 36, a rearward end 38, and an exterior surface 40. Penetrating the lower portion of frame 32 is all access port 42. Extending longitudinally within frame 32 are a lower cavity 44, which is defined by a lower-cavity sidewall 48, and an upper cavity 52 that is disposed above and aligned with the lower cavity. An intercavity passageway 56 couples lower cavity 44 in fluid communication with upper cavity 52. In upper cavity 52 is disposed a bolt 60, which is penetrated internally by a bolt propulsion gas passageway 64. Forward of bolt 60, within a gun firing chamber 66, is disposed a paintball 68, which is shown in position to be propelled forward and expelled from pneumatic gun 28 by a release of compressed gas, as explained below.

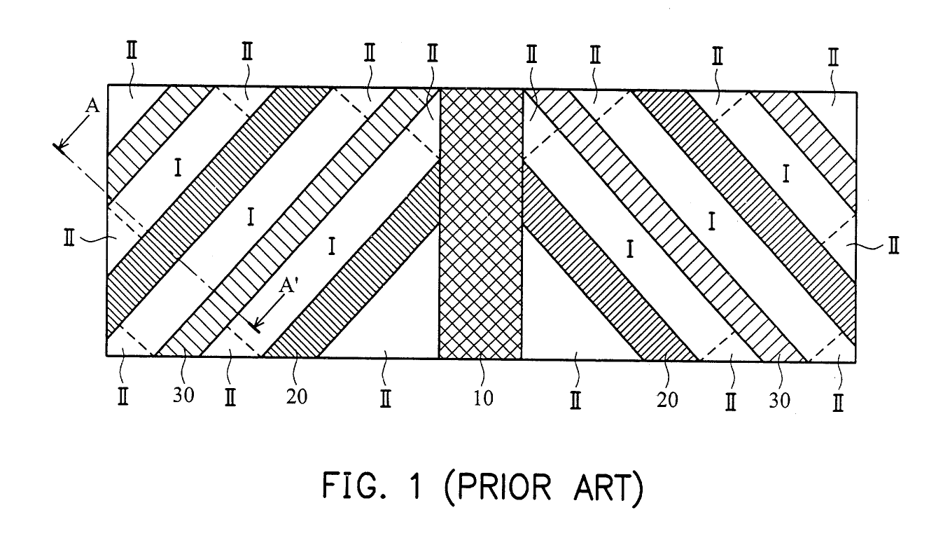

Referring again to FIG. 2, valve assembly 24 is disposed within lower cavity 44. Forward of valve assembly 24 within lower cavity 44 is a gas reservoir 72 that receives compressed gas from a gas cylinder 76. Rearward of valve assembly 24, within lower cavity 44, is a recock chamber 80. A hammer 84 is slidably translatable and for0 (such as bumps) are bright regions, and the other regions are dull regions II. Under actual measurement and calculation, the aperture ratio of the MVA pixel is 47%, better than the traditional MVA pixel, 30%, shown in FIG. 1. Therefore, the aperture ratio is improved 57%, and a high resolution LCD with MVA pixels can be obtained.

FIG. 5 shows a top view of the MVA pixels. The liquid crystal molecules at the left red dot tilt in a bottom right direction ( [symbol] ) and a top right direction ( [symbol] ), and the liquid crystal molecules at the middle red (R) dot tilt in a top left direction ( [symbol] ) and in a bottom left direction ( [symbol] ). Therefore, four domains are obtained with two pixel regions, and a wide view angle display is achieved.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A MVA pixel for a liquid crystal display comprising a liquid crystal layer between a first panel and a second panel, further comprising:
a protrusion element formed on an inner surface of the first panel; and
a conducting layer with a first slit and a second slit formed on an inner surface of the second panel, wherein the protrusion element faces the first slit.

2. The MVA pixel of claim 1, wherein the protrusion element is V-shaped or W-shaped.

3. The MVA pixel of claim 1, wherein the first slit and the second slit are V-shaped or W-shaped.

4. The MVA pixel of claim 1, wherein the protrusion element has a first portion (120) and a second portion (120′) , the first portion (120) is V-shaped or W-shaped, and the second portion (120′) is parallel to a periphery of the pixel and extends to the second slit.

5. The MVA pixel of claim 1, wherein the first panel is a quartz panel or glass panel.

6. The MVA pixel of claim 1, wherein the second panel is a quartz panel or a glass panel with an organic layer thereon.

7. The MVA pixel of claim 1, wherein the protrusion element is bumps.

8. The MVA pixel of claim 1, wherein the conducting layer is ITO or SnO.
